(19) United States
(12) Patent Application Publication
(10) Pub. No.: US 2008/0313887 A1
(43) Pub. Date: Dec. 25, 2008

(54) Method of producing printed circuit board incorporating resistance element

(76) Inventor: Garo Miyamoto, Ushiku-Shi (JP)

Correspondence Address: JACOBSON HOLMAN PLLC, 400 SEVENTH STREET N.W., SUITE 600, WASHINGTON, DC, 20004, US

(21) Appl. No.: 12/155,663

(22) Filed: Jun. 6, 2008

(30) Foreign Application Priority Data
Jun. 7, 2007 (JP) 2007-151862

(51) Int. Cl. H01C 17/06; H01C 17/00

(52) U.S. Cl. 29/610.1; 29/620; 29/830; 29/846; 29/832

(57) ABSTRACT

The present invention provides a method of producing a resistance element incorporated in a printed circuit board at an accuracy of resistance value of ±1% or less, at low cost and with a good yield while the resistance element formed by a resistor paste is incorporated. A method of producing a printed circuit board incorporating a resistance element includes: preparing a double-sided copper clad board having a first metallic foil on one face of an insulating base material thereof and a second metallic foil on the other face of the insulating base material thereof; providing at least a pair of electrodes on one of the metallic foils; printing a resistor paste between the electrodes to form a resistor; preparing a circuit board having at least one wiring layer; causing a layer on which the resistor paste is formed to oppose the circuit board to layer the double-sided copper clad board on the circuit board; forming openings in the first and the second metallic foils; and emitting laser through the openings to partly remove the insulating base material and the resistor paste to adjust resistance value. A conformal mask for etching may be formed on the second metallic foil to form openings in the insulating base material by etching to emit laser through the openings.

### CROSS REFERENCE TO RELATED APPLICATIONS

This application is based upon and claims the benefit of priority from the prior Japanese Patent Application No. 2007-151862, filed on Jun. 7, 2007, the entire contents of which are incorporated herein by reference.

### BACKGROUND OF THE INVENTION

1. Field of the Invention

The present invention relates to the structure of a printed circuit board and a method of producing the same, and in particular, to a printed circuit board incorporating a resistance element and a method of producing the same.

2. Related Art

In recent years, components have been densely mounted as electronic apparatus is downsized and sophisticated. For this reason, there has been studied a circuit-board incorporating a component, inside which passive components are formed to increase a mounting density, instead of conventionally soldering passive components such as resistors and capacitors as chip components onto the surface of a circuit board.

A method of forming a resistor out of passive components inside a board has been practically used in a ceramic multilayer board. However, the resistor is formed by screen printing, so that a resistance value is considerably dispersed, the resistor needs trimming by laser or sand blasting after baked to be adjusted to a desired resistance.

A baking temperature used in the method is as high as 500° C. or more, so that the method cannot be applied to an organic circuit board. As an attempt to an organic circuit board, there has been studied a method in which a resistor thin film is formed on the entire surface of the board to obtain a desired resistor by etching or in which a resistor paste baked at a low temperature is formed by screen printing to obtain a desired resistor.

A resistor formed inside the board needs to be applicable to a required wide resistance value and small in the dispersion of resistance value, that is, high in the pattern accuracy of the resistor and uniform in the film thickness thereof.

In the above thin film method, a resistor pattern is high in accuracy, however, the film is thin, so that the obtained range of resistance value is narrow. On the other hand, in the resistor paste method, the obtained range of resistance value is wide, however, the accuracy of a resistor pattern formed by screen printing and the uniformity of film thickness thereof are inferior. For this reason, the resistor paste method needs laser trimming to improve the accuracy of resistance value.

It has been known that the resistor formed by the resistor paste method varies in resistance value when the resistor is layered to be incorporated inside the board. The amount of variation in resistance value is different depending on layering condition, the kinds of a layering adhesive and the film thickness and size of a resistor paste, so that it is difficult to estimate the amount of variation in resistance value due to layering in advance to perform trimming, obtaining a desired resistance value after the resistor has been layered.

A circuit board incorporating a resistance element described in Japanese Patent Laid-Open No. 2006-156746 (P5, paragraph number 0020) forms a nickel alloy thin film between a resistor paste and an electrode to prevent variation in resistance value at high temperature and high humidity, but the board cannot suppress variation in resistance value due to layering.

A circuit board incorporating a resistance element described in Japanese Patent Laid-Open No. 2006-222110 (P3, paragraph number 0006) forms a substitutional electroless silver plating film between a resistor paste and an electrode to prevent variation in resistance value at high temperature and high humidity, but the board cannot suppress variation in resistance value due to layering.

In a circuit board incorporating a resistance element described in Japanese Patent Laid-Open No. 2004-335827 [P3 (paragraph number 0012) to P4 (paragraph number 0013)], a method of trimming to adjust resistance value is devised. The resistance value of the element can be adjusted, but the method of adjusting the resistance value cannot be determined until the resistance value is measured, so that a process is complicated. Variation in resistance value due to layering after the resistance value is adjusted is not considered.

In a circuit board incorporating a resistance element described in Japanese Patent Laid-Open No. 2000-174405 (P2, paragraph number 0011), a through hole is filled with resistor paste, so that the board itself serves as a spacer, enabling suppressing variation in resistance value due to layering.

However, it is difficult to form a resistor having a highly accurate resistance value by merely filling the though hole with the paste. Moreover, the resistance value cannot be adjusted by laser trimming in terms of structure.

Since a termination resistor for a transmission line and a filter resistor for electromagnetic interference (EMI) are required to satisfy an accuracy of resistance value of ±1% or less, the above method is not enough to satisfy the requirement.

Under the above situations, there has been demanded a technique in which a termination resistor for a transmission line and a filter resistor for EMI having an accuracy of resistance value of ±1% or less are formed at a low cost with the resistors incorporated in the circuit board. In order to achieve the above demand, the resistance value needs to be adjusted by trimming the variation in resistance value due to layering.

FIG. 3 is a cross section illustrating the method, described in Japanese Patent Laid-Open No. 2006-156746, of producing a printed circuit board incorporating a resistance element using a resistor paste. A so-called double-sided copper clad laminate having a first and a second conductor layers of copper foil on both sides of an insulating base material of polyimide therein is prepared and a through hole is formed in a required position using drilling or laser process.

Thereafter, a conducting process is performed to form a plating film and a circuit pattern is formed using an etching method which makes use of ordinary photofabrication techniques to provide a double-sided printed circuit board. Then, a nickel alloy thin film is formed on electrode portions which a resistor paste contacts and the resistor paste is formed between the electrodes covered with the nickel alloy thin film by screen printing.

The resistance value of the resistor paste is adjusted by trimming with laser light. A four-layered structure is formed by layering using copper foil with resin. Thereafter, a bottomed via hole used for performing interlayer conduction is formed by laser, conduction process is performed to form plating film and a circuit pattern is formed using an etching method making use of photofabrication techniques, thereby providing a printed circuit board incorporating a resistance element.

A termination resistor for a transmission line and a filter resistor for EMI are required to satisfy an accuracy of resistance value of ±% or less, however, an incorporated resistance element formed by resistor paste using a conventional technique cannot follow variation in resistance value before and after layering, so that it is difficult to form a resistor having an accuracy of resistance value of ±1% or less with a good yield with the resistor incorporated in a circuit board.

### SUMMARY OF THE INVENTION

The present invention has been made in view of the above points and has its object to provide a method of producing a resistance element incorporated in a printed circuit board at an accuracy of resistance value of ±1% or less, at low cost and with a good yield while the resistance element formed by a resistor paste is incorporated.

The present application provides the following invention to achieve the above object.

A method of producing a printed circuit board incorporating a resistance element according to a first aspect of the present invention includes: preparing a double-sided copper clad board having a first metallic foil on one face of an insulating base material thereof and a second metallic foil on the other face of the insulating base material thereof; providing at least a pair of electrodes on one of the metallic foils; printing a resistor paste between the electrodes to form a resistor; preparing a circuit board having at least one wiring layer; causing a layer on which the resistor paste is formed to oppose the circuit board to layer the double-sided copper clad board on the circuit board; forming openings in the first and the second metallic foils respectively; and emitting laser through the openings to partly remove the insulating base material and the resistor paste to adjust resistance value.

A method of producing a printed circuit board incorporating a resistance element according to a second aspect of the present invention includes: preparing a double-sided copper clad board having a first metallic foil on one face of an insulating base material thereof and a second metallic foil on the other face of the insulating base material thereof; providing a first and a second electrodes on the first metallic foil; forming a resistor paste between the first and the second electrodes by a printing method; preparing a circuit board having at least one wiring layer; causing a layer on which the resistor paste is formed to oppose the circuit board to layer the double-sided copper clad board on the circuit board; forming a conformal mask for etching on the second metallic foil; forming openings in the insulating base material by etching; and emitting laser through the openings to partly remove the resistor paste to adjust resistance value.

According to the present invention, an incorporated resistance element after layered can be directly adjusted in resistance value by trimming, so that a resistance element having a high accuracy of resistance value can be produced at low cost and with a good yield.

As a result, a print circuit board incorporating a high accurate resistance element such as a termination resistor for a transmission line and a filter resistor for EMI required to satisfy an accuracy of resistance value of ±1% or less can be stably produced at low cost.

### BRIEF DESCRIPTION OF THE DRAWINGS

FIG. 1A is a partial process chart illustrating a production process for a printed circuit board incorporating a resistance element in one embodiment of the present invention;

FIG. 1B is a partial process chart illustrating a production process for a printed circuit board incorporating a resistance element in one embodiment of the present invention;

FIG. 2A is a partial process chart illustrating a production process for a printed circuit board incorporating a resistance element in another embodiment of the present invention;

FIG. 2B is a partial process chart illustrating a production process for a printed circuit board incorporating a resistance element in another embodiment of the present invention; and

FIG. 3 is a cross section of a printed circuit board incorporating a resistance element produced by a conventional method.

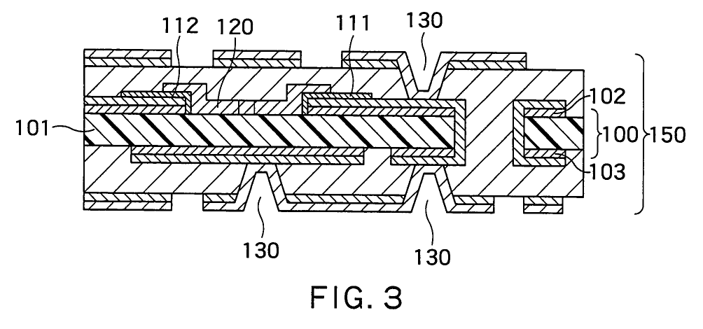

### DETAILED DESCRIPTION OF THE INVENTION

The embodiment of the present invention is described below with reference to the accompanied drawings.

### First Embodiment

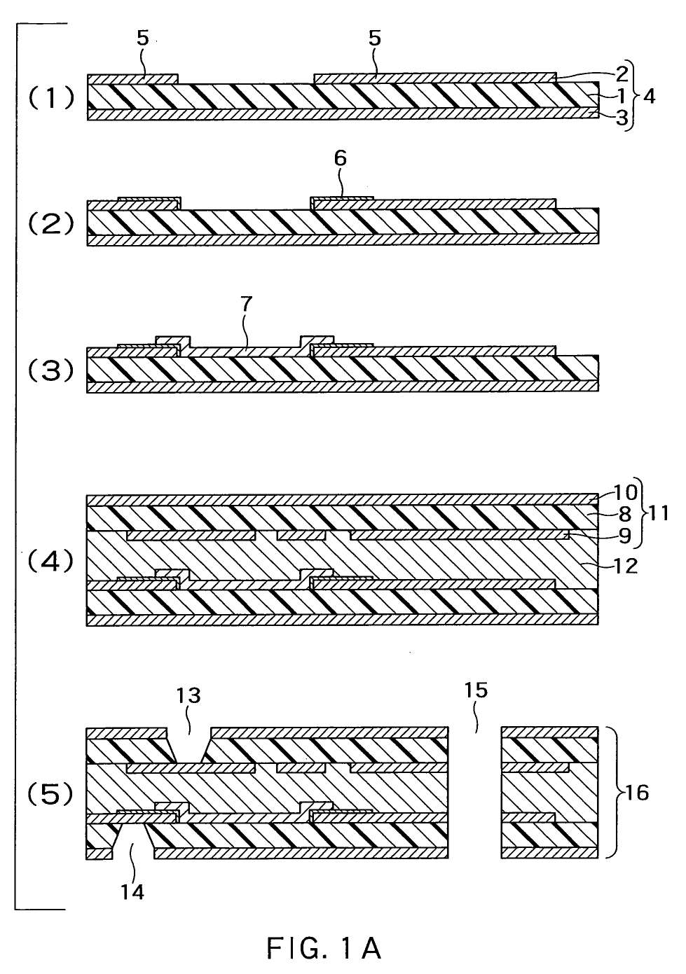

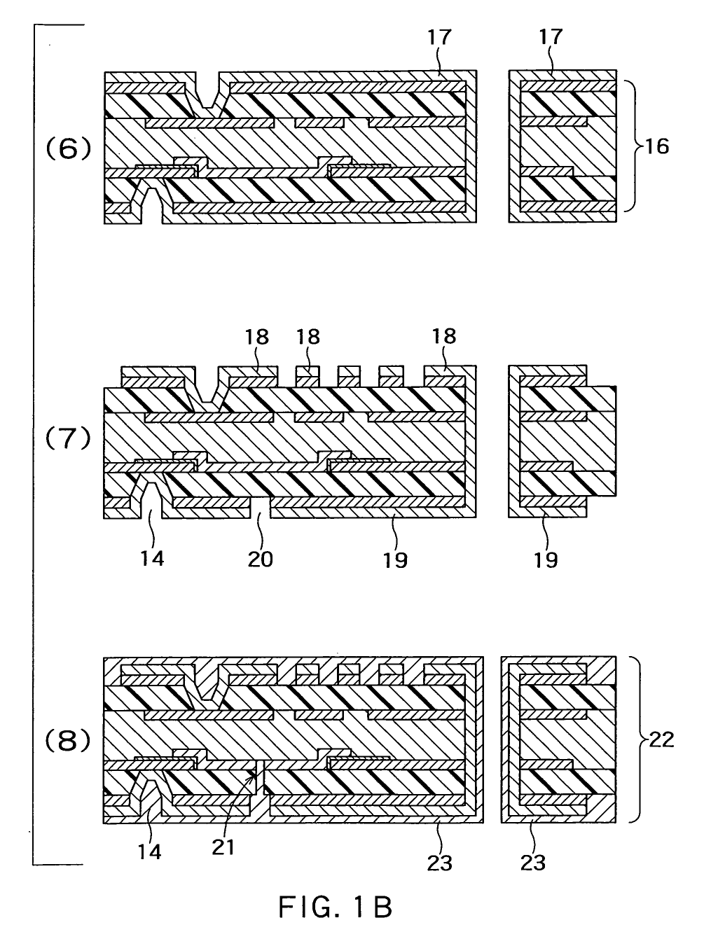

FIGS. 1A and 1B are cross section process charts illustrating a method of producing a printed circuit board incorporating a resistance element in one embodiment of the present invention. As illustrated in FIG. 1A(1), a so-called double-sided copper clad laminate 4 having a first metallic foil 2 and a second metallic foil 3 such as a copper foil on both sides of an insulating base material 1 of polyimide is prepared. An electrode 5 of a resistor paste and a circuit are formed in a required position of the first metallic foil 2 using an etching method making use of ordinary photofabrication techniques.

A 25 μm-thick polyimide was used as a base material and a 12 μm-thick electrolytic copper foil was used as the metallic foil. A resistance value is determined by the width and film thickness of the resistor paste, a distance between electrodes and the sheet resistance value of the resistor paste. The distance between electrodes was taken as 1.0 mm herein.

As illustrated in FIG. 1A(2), the electrode portion which the resistor paste contacts was subjected to a surface treatment of electroless Ag plating 6. The plating is approximately 0.2 μm in thickness. This surface treatment was performed to suppress variation in resistance value in a high temperature and high humidity test. It was confirmed that noble metal plating such as Ni plating and Au plating and printing using Ag paste achieved the same effect in addition to the above electroless Ag plating.

The electrode portion was partially plated herein. A dry film HY-920 produced by Asahi Kasei Corporation was used as a mask for the plating. Alternately, any other kind of a dry film may be used as the dry film unless it is acid proof.

As illustrated in FIG. 1A(3), a resistor paste 7 was formed on the electrode by a printing method and thermally hardened. A resistor paste TU-50-8 produced by Asahi Kaken with a sheet resistance value of 50Ω was used. Although the resistor paste 7 was formed using a screen printing method, any other method such as dispenser or inkjet may be used.

A resistance value is determined by the width and film thickness of the resistor paste, a distance between electrodes and the sheet resistance value of the resistor paste. The width of the resistor paste was taken as 1.0 mm herein. A plain weave stainless screen plate with the number of meshes of 400 and the thickness of emulsion of 10 mm was used as the screen plate. The resistor paste 7 was thermally hardened by a box hot-blast oven at a temperature of 170° C. for one hour.

As illustrated in FIG. 1A(4), a circuit formed surface of a double-sided copper clad laminate 11, in which a circuit is formed on the so-called double-sided copper clad laminate 11 having a first metallic foil 9 and a second metallic foil 10 such as a copper foil on both sides of an insulating base material 8 of polyimide in a required position of the first metallic foil 9 using an etching method making use of an ordinary photofabrication techniques, was layered over the surface on which the resistor paste 7 is formed through a layering adhesive 12.

As layering conditions, press was performed by a vacuum laminator at a temperature of 170° C., at a pressure of 2.0 MPa and for four minutes and then oven curing was performed by a box hot-blast oven at a temperature of 18° C. for two and a half hours.

As illustrated in FIG. 1A(5), bottomed via holes 13 and 14 and a through hole 15 used for interlayer conduction were formed by laser processing and drilling and then a circuit board 16 was subjected to a desmear treatment and a conduction treatment. As illustrated in FIG. 1B(6), a plating film 17 was formed.

As illustrated in FIG. 1B(7), an opening 20 for trimming circuit patterns 18 and 19 and the carbon paste is formed in the second metallic foil 3, the second metallic foil 10 and the plating film 17 using the etching method making use of photofabrication techniques. The opening with a diameter of 2.0 mm was formed in consideration of exposure positioning accuracy at the time of forming a circuit pattern to trim the 1-mm wide resistor paste.

As illustrated in FIG. 1B(8), the insulating base material and the resistor paste are removed by trimming 21 with UV-YAG laser through the opening 20. Resistance value is adjusted while resistance value is being measured, providing a printed circuit board 22 incorporating a resistance element with an accuracy of resistance value of ±1% or less.

The same effect can be achieved using any other laser source. After the printed circuit board 22 has been obtained, the surface of the printed circuit board is preferably covered with a photo solder resist 23. A cover material may be used instead of the photo solder resist. If polyimide is used as the insulating base material, polyimide is removed by resin etching method using a chemical treatment and then the resistor paste may be trimmed by laser.

In this case, a resin etching rate is different depending on kinds of polyimide film, so that a preferable kind of a flexible insulating base material is polyimide film obtained from the polycondensation of pyromelletic dianhydride and aromatic diamine (for example, kapton produced by DuPont Ltd. in USA or apical produced by Kanegafuchi Chemical Ind. Co., Ltd.) and other polyimide whose structure is similar thereto.

However, in the above method, the insulating base material facing the opening 20 is entirely removed, so that the hole filled with the cover or the photo solder resist is inevitably increased in diameter.

The method according to the present invention is used to adjust resistance value by trimming after resistance value has been varied due to layering, enabling surely forming the incorporated resistance element with an accuracy of resistance value of ±1% or less with a good yield, instead that variation in resistance value due to layering is estimated to offset the amount of variation in resistance value due to layering in advance to adjust the resistance value and then layering is performed.

### Second Embodiment

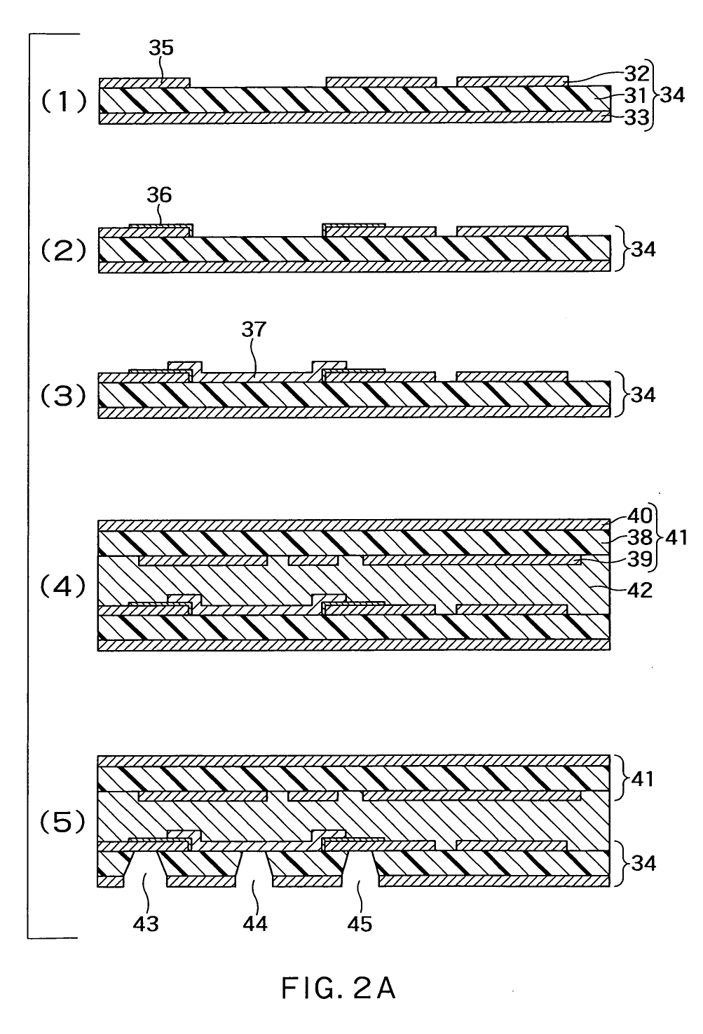

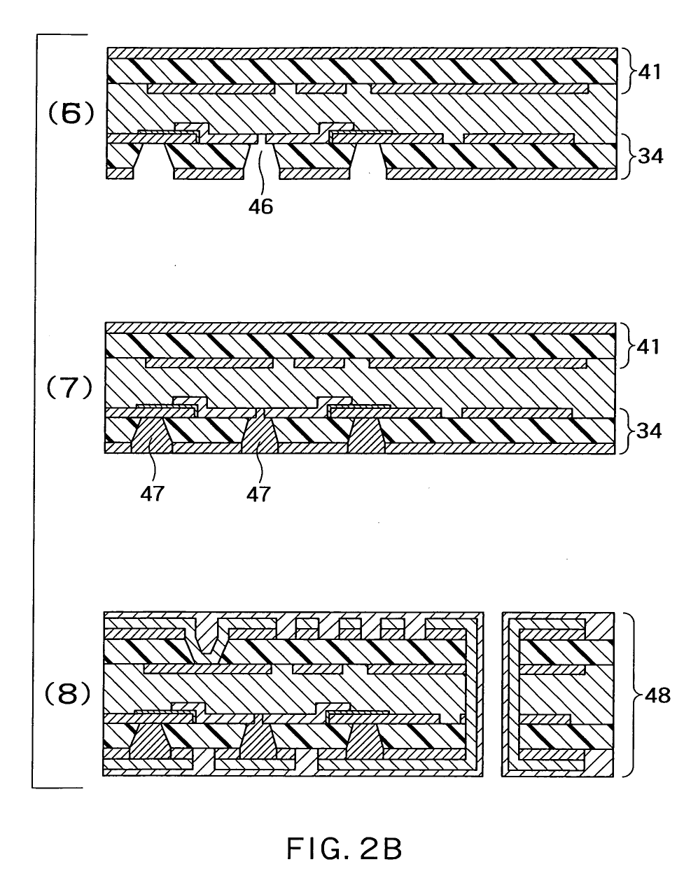

FIGS. 2A and 2B are cross section process charts illustrating a method of producing a printed circuit board incorporating a resistance element in one embodiment of the present invention. As illustrated in FIG. 2A(1), a so-called double-sided copper clad laminate 34 having a first metallic foil 32 and a second metallic foil 33 such as copper foil on both sides of an insulating base material 31 of polyimide is prepared. An electrode 35 of a resistor paste and a circuit are formed in a required position of the first metallic foil 32 using an etching method making use of ordinary photofabrication techniques.

A 25 μm-thick polyimide was used as a base material and 12 μm-thick electrolytic copper foil was used as the metallic foil. A resistance value is determined by the width and film thickness of the resistor paste, a distance between electrodes and the sheet resistance value of the resistor paste. The distance between electrodes was taken as 1.0 mm herein.

As illustrated in FIG. 2A(2), the electrode portion which the resistor paste contacts was subjected to a surface treatment of electroless Ag plating 36. The plating is approximately 0.2 μm in thickness. This surface treatment was performed to suppress variation in resistance value in a high temperature and high humidity test. It was confirmed that noble metal plating such as Ni plating and Au plating and printing using Ag paste achieved the same effect in addition to the above electroless Ag plating.

The electrode portion was partially plated herein. A dry film HY-920 produced by Asahi Kasei Corporation was used as a mask for the plating. Alternately, any other kind of a dry film may be used as the dry film unless it is acid proof.

As illustrated in FIG. 2A(3), a resistor paste 37 was formed on the electrode by a printing method and thermally hardened. A resistor paste TU-50-8 produced by Asahi Kaken with a sheet resistance value of 50Ω was used. Although the resistor paste 37 was formed using a screen printing method, any other method such as dispenser or inkjet may be used.

A resistance value is determined by the width and film thickness of the resistor paste, a distance between electrodes and the sheet resistance value of the resistor paste. The width of the resistor paste was taken as 1.0 mm herein. A plain weave stainless screen plate with the number of meshes of 400 and the thickness of emulsion of 10 mm was used as the screen plate. The resistor paste 37 was thermally hardened by a box hot-blast oven at a temperature of 170° C. for one hour.

As illustrated in FIG. 2A(4), a circuit formed surface of a double-sided copper clad laminate 41, in which a circuit is formed on the so-called double-sided copper clad laminate 41 having a first metallic foil 39 and a second metallic foil 40 such as a copper foil on both sides of an insulating base material 38 of polyimide in a required position of the first metallic foil 39 using an etching method making use of an ordinary photofabrication techniques, was layered over the surface on which the resistor paste 37 is formed through a layering adhesive 42.

As layering conditions, press was performed by a vacuum laminator at a temperature of 170° C., at a pressure of 2.0 MPa and for four minutes and then oven curing was performed by a box hot-blast oven at a temperature of 18° C. for two and a half hours.

As illustrated in FIG. 2A(5), openings 43, 44 and 45 were formed in the second metallic foil 33 using the etching method making use of photofabrication techniques. After that, the openings 43, 44 and 45 were subjected to resin etching using chemical treatment.

In this case, a resin etching rate is different depending on kinds of polyimide film, so that a preferable kind of a flexible insulating base material is polyimide film obtained from the polycondensation of pyromelletic dianhydride and aromatic diamine (for example, kapton produced by DuPont Ltd. in USA or apical produced by Kanegafuchi Chemical Ind. Co., Ltd.) and other polyimide whose structure is similar thereto.

As illustrated in FIG. 2B(6), the resistor paste was trimmed 46 using UV-YAG laser through the opening 44 subjected to resin etching. Resistance value was measured through a probe in the openings 43 and 45 subjected to resin etching at the time of trimming to adjust the resistance value to a target resistance value.

As illustrated in FIG. 2B(7), the openings were plugged with an insulating paste 47 by screen printing and thermally hardened. The paste used is a plugging paste “THP-100DX1-450PS” produced by Taiyo Ink Mfg. Co., Ltd. The paste was hardened by a box hot-blast oven at a temperature 150° C. for one hour. The insulating paste may be formed by the dispenser method as well as screen printing.

As illustrated in FIG. 2B(8), a hole used for interlayer conduction was formed by drilling and laser processing and then a desmear treatment, a conduction treatment, a plating film formation and a photofabrication were performed to form a circuit before a photo solder resist was formed, thereby providing a printed circuit board 48 incorporating a resistance element with an accuracy of resistance value of ±1% or less.

The method according to the present invention is used to adjust resistance value by trimming after resistance value has been varied after layering, enabling surely forming the incorporated resistance element with an accuracy of resistance value of ±1% or less with a good yield, instead that variation in resistance value due to layering is estimated to offset the amount of variation in resistance value due to layering in advance to adjust the resistance value and then layering is performed.

What is claimed is:

1. A method of producing a printed circuit board incorporating a resistance element comprising:
preparing a double-sided copper clad board having a first metallic foil on one face of an insulating base material thereof and a second metallic foil on the other face of the insulating base material thereof;
providing at least a pair of electrodes on one of the metallic foils;
printing a resistor paste between the electrodes to form a resistor;
preparing a circuit board having at least one wiring layer;
causing a layer on which the resistor paste is formed to oppose the circuit board to layer the double-sided copper clad board on the circuit board;
forming openings in the first and the second metallic foils; and
emitting laser through the openings to partly remove the insulating base material and the resistor paste to adjust resistance value.

2. A method of producing a printed circuit board incorporating a resistance element comprising:
preparing a double-sided copper clad board having a first metallic foil on one face of an insulating base material thereof and a second metallic foil on the other face of the insulating base material thereof;
providing a first and a second electrodes on the first metallic foil;
forming a resistor paste between the first and the second electrodes by a printing method;
preparing a circuit board having at least one wiring layer;
causing a layer on which the resistor paste is formed to oppose the circuit board to layer the double-sided copper clad board on the circuit board;
forming a conformal mask for etching on the second metallic foil;
forming openings in the insulating base material by etching; and
emitting laser through the openings to partly remove the resistor paste to adjust resistance value.
